(19) United States
(12) Patent Application Publication
(10) Pub. No.: US 2013/0021695 A1
(43) Pub. Date: Jan. 24, 2013

(54) BASE DESIGN OF MAGNETIC DISK DRIVE

(71) Applicants: Taisuke SUGII, Ibaraki (JP); Yoshiyuki HIRONO, Kanagawa (JP); Takanori KAWAKAMI, Kanagawa (JP)

(72) Inventors: Taisuke SUGII, Ibaraki (JP); Yoshiyuki HIRONO, Kanagawa (JP); Takanori KAWAKAMI, Kanagawa (JP)

(21) Appl. No.: 13/187,406

(22) Filed: Jul. 20, 2011

(51) Int. Cl. G11B 17/00

(52) U.S. Cl. 360/97.11; G9B/17.001

(57) ABSTRACT

A magnetic disk device including: one or more disk-shaped magnetic disks; a spindle motor; a magnetic head; an arm for supporting the magnetic head; an enclosure base for housing the above components; an adjacent facing surface which lies in the enclosure base adjacent to the magnetic disk; a non-adjacent facing surface which lies in the enclosure opposite the magnetic disk and is further from the magnetic disk than the adjacent facing surface; a connecting surface for connecting the adjacent facing surface and the non-adjacent facing surface; and a groove which extends in the circumferential direction of the magnetic disk on the magnetic disk inner circumferential side of the adjacent facing surface, wherein one end of the groove is exposed at the connecting surface, while the other end has an end face which is perpendicular to the direction of rotation of the magnetic disk.

### FIELD OF THE INVENTION

The present technology relates generally to the magnetic disk device field. More particularly, the present technology relates to an enclosure base shape in a magnetic disk device.

### BACKGROUND OF THE INVENTION

In general, due to the extremely close spacing between the magnetic head of a hard disk drive and a disk surface, hard disk drives are vulnerable to being damaged by a head crash, which is a failure of the disk in which the magnetic head scrapes across the platter surface, often grinding away the thin magnetic film and causing data loss. Head crashes can be caused by, among other things, contaminants within the drive's internal enclosure.

### BRIEF DESCRIPTION OF THE DRAWINGS

FIG. 1 is an oblique view of a magnetic disk device, showing a state in which the enclosure cover has been removed.

FIG. 2 is a view in longitudinal section of a spindle motor in a magnetic disk device.

FIG. 3 is an oblique view of a magnetic disk device, showing a state in which the enclosure cover, magnetic disks, carriage, pivot shaft, and voice coil motor (VCM) have been removed.

FIG. 4 is an oblique view of a magnetic disk device according to an embodiment of the present technology of the airflow control mechanism, showing a state in which the enclosure cover, magnetic disks, carriage, pivot shaft, and voice coil motor (VCM) have been removed.

FIG. 5 is a diagram showing a variant example of the airflow control mechanism shown in FIG. 4, in accordance with one embodiment of the present technology.

FIG. 6 is a diagram showing a variant example of the airflow control mechanism shown in FIG. 4, in accordance with one embodiment of the present technology.

FIG. 7 is an oblique view of magnetic disk device showing a state in which the enclosure cover, magnetic disks, carriage, pivot shaft, and voice coil motor (VCM) have been removed, in accordance with one embodiment of the present technology.

FIG. 8 is a diagram showing a variant example of the airflow control mechanism shown in FIG. 7, in accordance with one embodiment of the present technology.

The drawings referred to in this description should not be understood as being drawn to scale unless specifically noted.

### DESCRIPTION OF EMBODIMENTS

The discussion will begin with an overview of a magnetic disk device and a description of the pathway within the magnetic disk device traveled by contaminants such as dust particles that are generated by the rotation of the magnetic disks within. The discussion will then focus on a more detailed description of embodiments of the present technology, a magnetic disk device that provides for reducing a number of contaminants scattered from an internal space of a spindle motor of the magnetic disk device, thereby improving the magnetic disk device's reliability.

### Overview

In general, embodiments of the present technology reduce reading/writing errors caused by the scattering in the disk compartment of the contaminants present in the minute gap and the internal space of a spindle motor of the magnetic disk device. In one embodiment, the amount of airflow passing through the inside of the spindle motor is reduced.

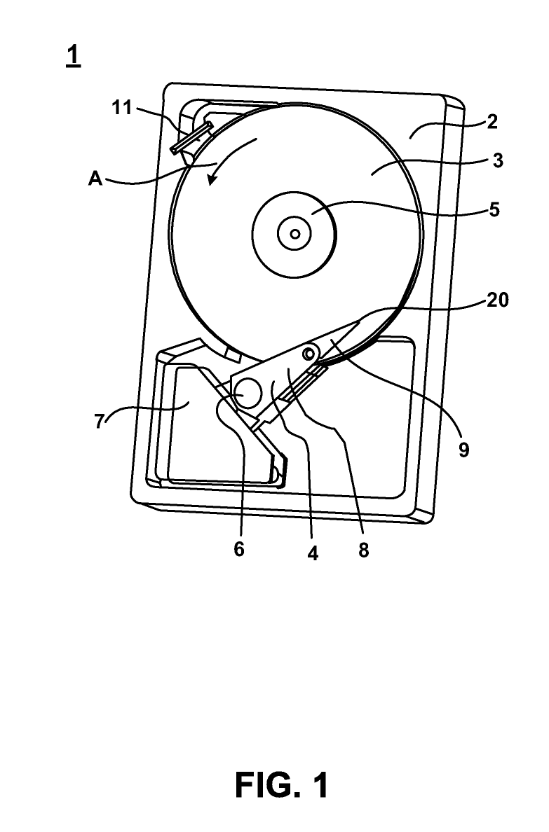

With regards to FIG. 1, an oblique view of a magnetic disk device is shown. Note that FIG. 1 shows a state in which the enclosure cover has been removed so that it is easier to see the inside of the device. A magnetic disk device 1 has a structure comprising one or more disk-shaped magnetic disks 3 which are driven in rotation in a counterclockwise direction by means of a spindle motor 5 at a speed of rotation of 7200 min⁻¹, for example. Inside an enclosure base 2, a carriage 4 is attached to a pivot shaft 6 in such a way as to be able to rotate through a prescribed angular range. The carriage 4 has a structure such that a drive force is received form a voice coil motor (VCM) 7 so that a carriage arm 8 thereof pivots through a prescribed angular range. The base end of a load beam 9 which has a magnetic head 20 mounted at the tip end thereof for reading/writing data is connected to the tip end of the carriage arm 8. The drive of the voice coil motor (VCM) 7 causes the carriage arm 8 to pivot through a prescribed angular range so that the magnetic head 20 is moved over the required track and data can be read/written.

When contaminants are present inside the magnetic disk device, these contaminants are scattered inside the enclosure as they are carried by airflow A generated by the rotation of the magnetic disks, and either settles on the surface of the magnetic disks or enters the gap between the magnetic disks and the slider, which may cause unstable flying of the slider, head crash, or damage to the magnetic disks, among other things. Measures therefore have to be taken during the production process in order to inhibit generation of contaminants, such as controlling the cleanliness of the components, optimizing the cleaning process, and managing the element content of the component materials. A filter 11 for trapping contaminants is further provided inside the magnetic disk device so that a clean state is maintained within the magnetic disk device.

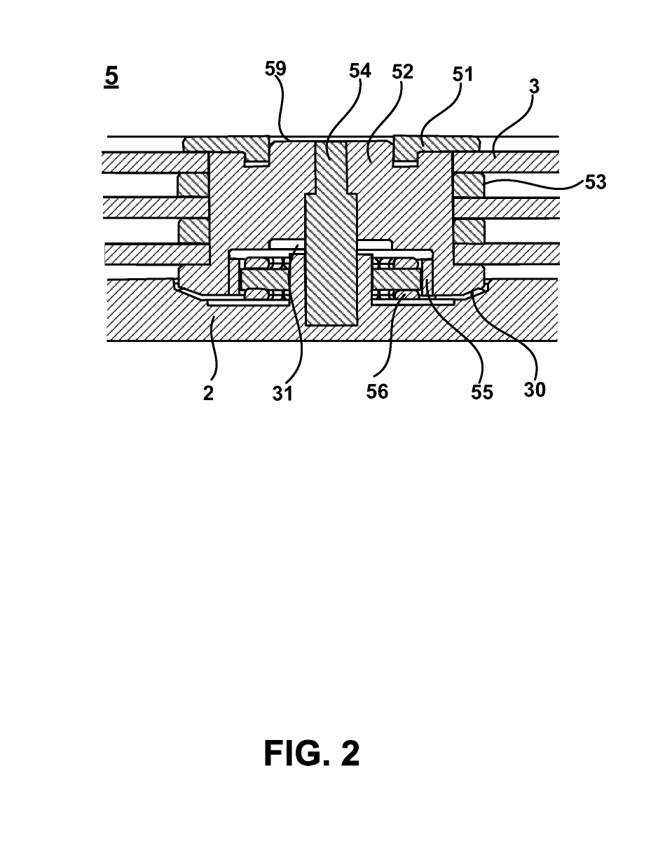

Furthermore, FIG. 2 shows a view in cross section of the spindle motor 5. The spindle motor 5 comprises a rotary part 59 including a hub 52 for holding the magnetic disks 3, a shaft 54 which fits together with the hub 52, and a rotor magnet 55 provided on the inner wall of the hub 52. Disk spacers 53 are provided between the magnetic disks 3 so that the magnetic disks 3 are stacked with a constant gap there between. Furthermore, the magnetic disks 3 and the disk spacers 53 are screw-clamped to the hub 52 by means of a disk clamp 51 at the upper part of the top disk, which is the magnetic disk closest to the enclosure cover. The rotary part 59 produces a rotary force from a stator coil 56 in order to cause rotary movement about the shaft 54. A minute gap 30 is present between the enclosure base 2 and the rotary part 59 so that the rotary movement of the rotary part 59 is not impeded.

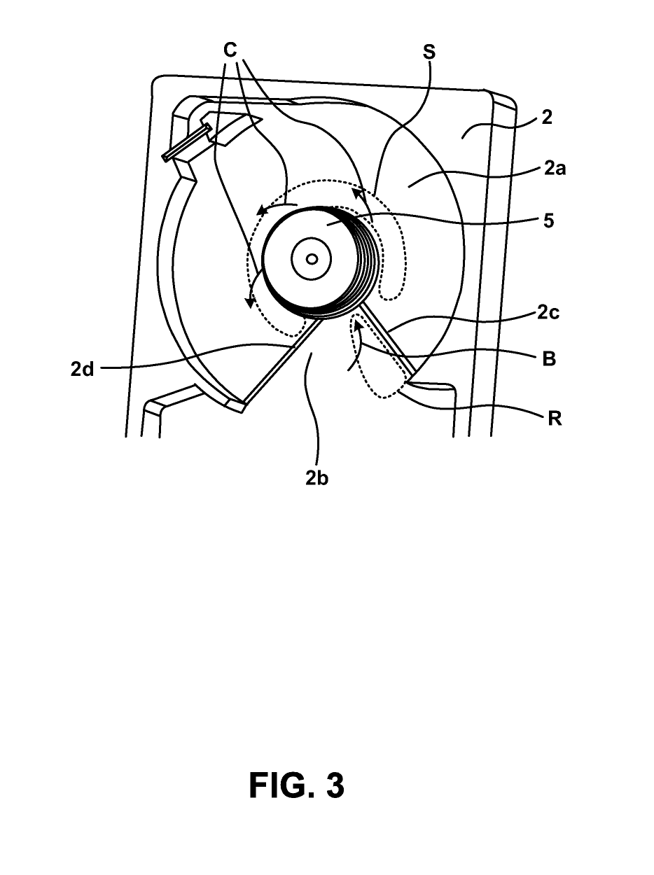

FIG. 3 represents an example of the magnetic disk device shown in FIG. 1, but in the state shown here, the enclosure cover, magnetic disk 3, carriage 4, pivot shaft 6, and voice coil motor (VCM) 7 etc. have been removed in order to make it easier to see the enclosure base 2. As shown in FIG. 3, a facing surface 2a, which lies opposite the magnetic disks 3 is formed close to the magnetic disks 3 within the enclosure base 2 in order to reduce vibration of the magnetic disks 3. However, because it is necessary to insert the carriage 4 into the space between the magnetic disks 3 and the enclosure base 2, a facing surface 2b which is present in the range where the carriage 4 is inserted is formed further away from the magnetic disks 3 than the facing surface 2a in order to maintain a gap for the insertion of the carriage 4. The facing surface 2a and the facing surface 2b are connected by means of a connecting surface 2c and a connecting surface 2d. The connecting surface 2c often has a tapered shape in order to suppress fluctuations in airflow. Airflow is generated inside the enclosure by rotation of the magnetic disks 3, but in the conventional example this airflow strikes the connecting surface 2c so there is an increase in pressure in the region R, which is the region upstream of the connecting surface 2c. Furthermore, the rotation of the magnetic disks 3 causes a rise in pressure in the outer circumferential region of the magnetic disks 3, and a drop in pressure in the inner circumferential region S. This means that a high-pressure region R and a low-pressure region S are formed outside the spindle motor 5, and airflow from the region R toward the region S is generated. Specifically, as shown by the arrow B in FIG. 3, this airflow flows from the region R into an internal space 31 (FIG. 1) of the spindle motor 5 through the minute gap 30 (shown in FIG. 2), and then once again flows out to the disk compartment through the minute gap 30, as shown by the arrows C. At this point, there is a risk of the contaminants which are present in the minute gap 30 and the internal space 31 of the spindle motor 5 being scattered in the disk compartment, causing data reading/writing errors. Methods of preventing this include increasing the level of cleanliness inside the spindle motor or reducing the amount of airflow passing through the inside of the spindle motor. With the method of increasing the level of cleanliness, it is necessary to place restrictions on the material of the coil and the various components and to control the level of cleanliness to a high degree, so higher costs are entailed. The basic measure for resolving the issue therefore involves reducing the amount of airflow passing through the inside of the spindle motor.

The inventive embodiments disclosed in published U.S. patent application US005453890A confront this problem by providing radial fins in the enclosure base in order to slow the speed of the airflow, so that reductions in pressure at the inner circumferential side of the disks is prevented and the amount of airflow passing through the inside of the spindle motor is reduced.

With the structure disclosed in published U.S. patent application US005453890A, there is a possibility that a high-pressure region and a low-pressure region will be produced in the circumferential direction in the inner circumferential region of the magnetic disks 3 and the region outside the spindle motor 5. In this case, airflow invades the minute gap 30 from the high-pressure region and flows out to the low-pressure region having passed through the internal space 31. In addition, when the above mentioned connecting surface 2c is present, a high-pressure region is formed upstream of the connecting surface 2c, and airflow invades the minute gap 30 as the high-pressure region prevails.

Embodiments of the present technology makes it possible to reduce the number of contaminants scattered form the internal space of the spindle motor, and makes it possible to further improve the reliability of the magnetic disk device.

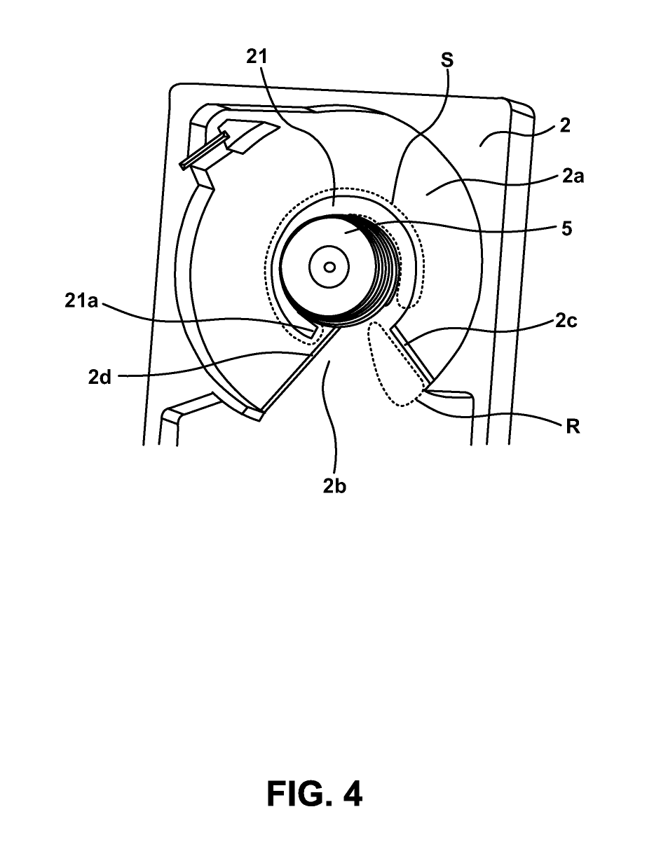

Referring now to FIG. 4, a magnetic disk device with an airflow control mechanism is shown, is accordance with an embodiment of the present technology. It should be noted that in the state shown here, the enclosure cover, magnetic disks, carriage, pivot shaft, and voice coil motor (VCM) etc. have been removed in order to make it easier to see an enclosure base 2. High pressure is produced at the outer circumferential side of the magnetic disks and low pressure is produced at the inner circumferential side thereof by the airflow generated as the magnetic disks rotate. Meanwhile, a facing surface 2a which is opposite the magnetic disks is formed close to the magnetic disks in order to reduce vibration of the magnetic disks. Furthermore, because it is necessary to insert the carriage into the space between the magnetic disks and the enclosure base 2, a facing surface 2b which is present in the range where the carriage is inserted is formed further away from the magnetic disks 3 than a facing surface 2a. In addition, the facing surface 2a and the facing surface 2b are connected by means of a connecting surface 2c and a connecting surface 2d. In this exemplary embodiment, a groove 21 extending in the circumferential direction of the magnetic disks is provided at the magnetic disk inner circumferential side of the enclosure base 2. One end of the groove 21 is exposed at the connecting surface 2c, while the other end of the groove 21 forms an end face 21a perpendicular to the magnetic disks.

As shown in FIG. 3, there is a rise in pressure in the upstream region R of the connecting surface 2c and a drop in pressure in the inner circumferential region S of the magnetic disks, and this generates a flow of air which passes through the inside of the spindle motor 5. In an embodiment of the present technology, the groove 21 which is exposed at the connecting surface 2c is formed on the inner circumferential side, and therefore it is possible to prevent pressure increases in the upstream region R of the connecting surface 2c. Furthermore, the end face 21a of the groove 21 is formed in the inner circumferential region S of the magnetic disks, and therefore an effect is achieved whereby airflow strikes the end face 21a and the pressure in the region S is increased. That is, the groove 21 produces an effect whereby the pressure on the inner circumferential side is made uniform in the circumferential direction of the magnetic disks. This means that the pressure difference between the region S and the region R is reduced, and therefore the amount of airflow passing through the spindle motor 5 decreases, and the number of contaminants scattered from the internal space of the spindle motor 5 can be reduced.

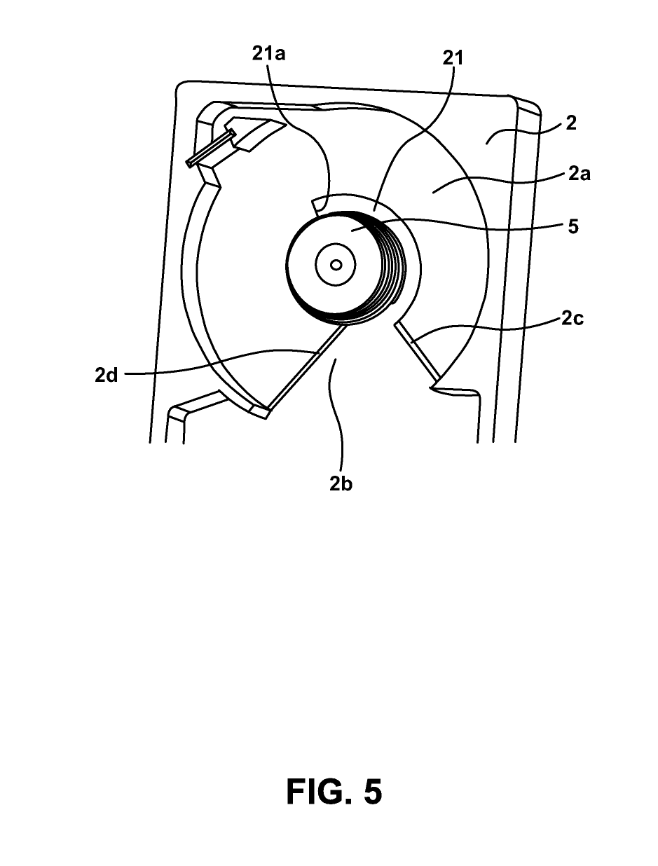

Furthermore, the length of the groove 21 in the circumferential direction is not limited to the length shown in FIG. 4. As shown in FIG. 5, a length of around half the circumference of the magnetic disks is equally feasible, or a length which is greater or less than this is also possible. The position at which the pressure is lowest in the inner circumferential region S of the magnetic disks varies according to various conditions, such as the size of the magnetic disks, the speed of rotation thereof, the position of the arm, and the shape of the components inside the magnetic disk device. The groove end part 21a is provided at the position at which the pressure is lowest. The optimal position for the groove end part 21a may therefore be determined by experimentation and numerical analysis.

Furthermore, in an embodiment, the facing surface 2b and the groove 21 are smoothly connected, and the distance from the magnetic disk surface to the facing surface 2b is equal to the distance from the magnetic disk surface to the groove 21. However, the present technology is not limited to this embodiment, and the facing surface 2b and the groove 21 do not have to be equidistant from the magnetic disk surface.

Furthermore, in an embodiment, the groove end part 21a is a surface which is perpendicular to the magnetic disk, but a taper in which the flow passage becomes narrower in the direction perpendicular to the magnetic disks may equally be formed at the groove end part in the direction of rotation of the magnetic disks. Furthermore, the length of the taper in the circumferential direction of the magnetic disks is not limited in this case.

Moreover, in an embodiment, the width of the groove 21 in the radial direction of the magnetic disks is constant, but the width may equally vary along the circumferential direction. However, if the width of the groove 21 in the radial direction of the magnetic disks is increased up to the outer circumferential region of the magnetic disks, there is a possibility of deterioration in magnetic disk vibration. For this reason, the width of the groove 21 is narrowed to a range which allows the amount of airflow passing through the spindle motor 5 to be reduced.

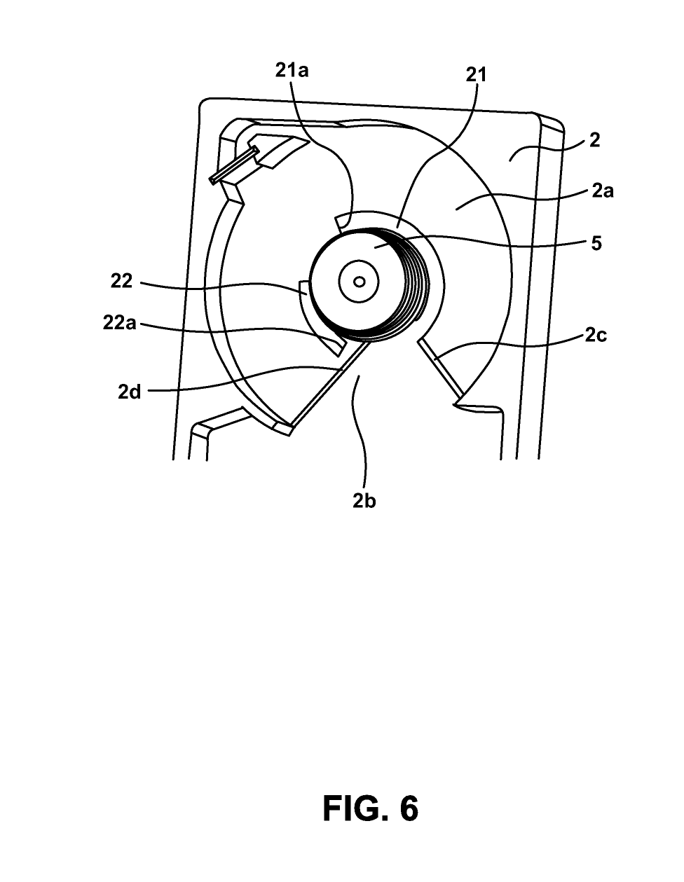

Referring now to FIG. 6, a diagram showing a variant example of airflow control mechanism shown in FIG. 4 is shown, in accordance with an embodiment of the present technology. A plurality of inner circumferential grooves may be formed in the circumferential direction of the magnetic disks. In this case, the plurality of grooves 21, 22 and groove end parts 21a, 22a are disposed in the places of reduced pressure, as described above, and the positions where they are disposed are appropriate for various conditions such as the size of the magnetic disks and the speed of rotation thereof. Furthermore, a plurality of grooves may be formed in the radial direction of the magnetic disks. However, if a plurality of grooves is provided, the end part of at least one of the grooves is exposed at the connecting surface 2c.

Furthermore, there are three magnetic disks in the embodiment, but the present technology is not limited by the number of magnetic disks, and one or a number of other than three magnetic disks may be employed. The speed of rotation employed for the magnetic disks is often between 2400 min⁻¹ and 15,000 min⁻¹, but a higher or lower speed is equally possible.

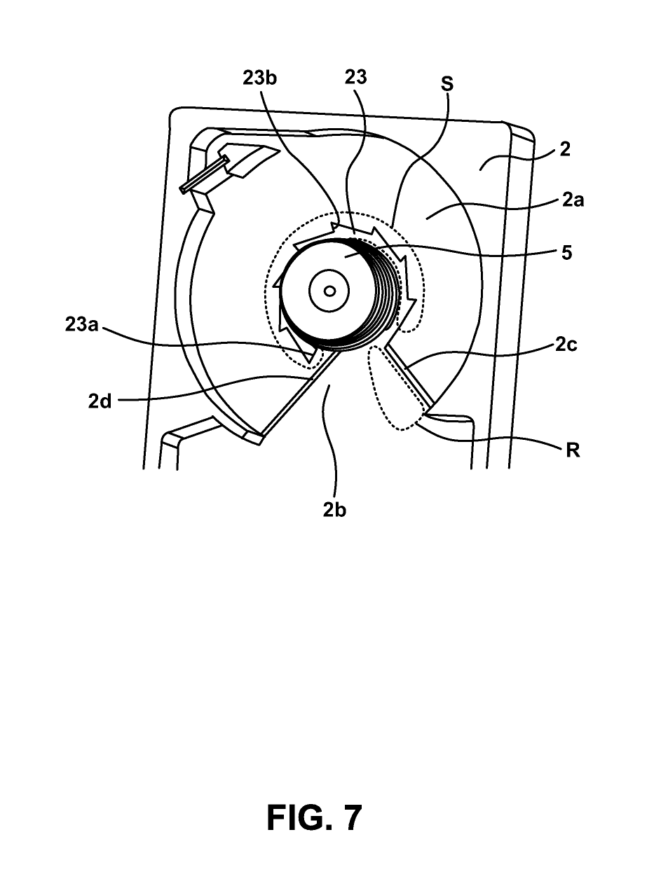

Referring now to FIG. 7, a magnetic disk device according to another embodiment of the airflow control mechanism is shown, showing a state in which the enclosure cover, magnetic disks, carriage, pivot shaft, and voice coil motor have been removed. In this embodiment, a groove 23 is formed on the magnetic disk inner circumferential side of the facing surface 2a in the enclosure base 2. The groove 23 has one end exposed at the connecting surface 2c while the other end is formed with an end face 23a perpendicular to the magnetic disk surface. In addition, the groove 23 has pressure-increasing parts 23b which check the airflow generated by the rotation of the magnetic disks and increases the pressure. In this embodiment, the pressure-increasing parts 23b have a surface perpendicular to the magnetic disk surface. By means of these surfaces, the pressure in the region S is effectively increased, and the pressure difference between the region R and the region S is reduced. The amount of airflow passing through the inside of the spindle motor 5 can therefore be reduced.

In this embodiment, the pressure-increasing parts 23b are provided in seven locations, but the present technology is not limited to this number. Furthermore, in the embodiment, the pressure-increasing parts 23b are wedge-shaped, but they are not limited to this shape. The position, number and shape of the pressure-increasing parts are selected to be suitable for various conditions such as the size of the magnetic disks and the speed of rotation thereof.

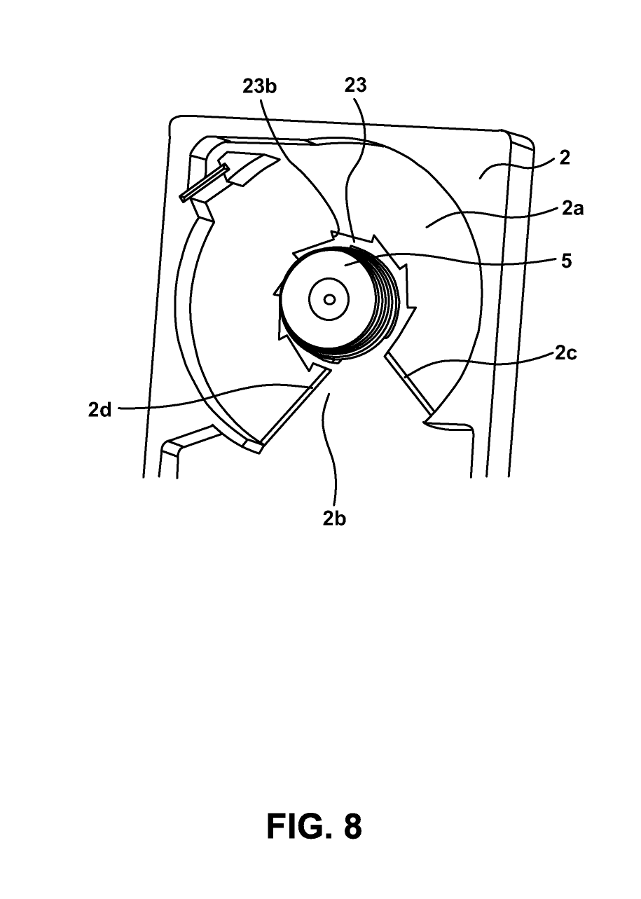

Referring now to FIG. 8, a diagram showing a variant of the airflow control mechanism shown in FIG. 7 is shown, in accordance with an embodiment of the present technology. As shown in FIG. 8, the groove 23 may be exposed at the connecting surface 2d. That is, the groove 23 does not have to have the end face 23a if the required pressure increase can be anticipated form the pressure-increasing parts 23b.

Thus, embodiments of the present technology provide an airflow control mechanism which reduces the number of contaminants scattered in order to further improve the reliability of the magnetic disk device.

Embodiments of the present technology are described above, but the present invention is not limited to this mode of embodiment, and various modifications may of course be implemented by a person skilled in the art.

What is claimed is:

1. A magnetic disk device comprising:
one or more disk-shaped magnetic disks;
a spindle motor for driving the magnetic disk in rotation;
a magnetic head for reading/writing magnetic information on the magnetic disk;
an arm for supporting the magnetic head;
an enclosure base for housing the above components;
an adjacent facing surface which lies in the enclosure base adjacent to the magnetic disk;
a non-adjacent facing surface which lies in the enclosure opposite the magnetic disk and is further from the magnetic disk than the adjacent facing surface;
a connecting surface for connecting the adjacent facing surface and the non-adjacent facing surface; and
a groove which extends in the circumferential direction of the magnetic disk on the magnetic disk inner circumferential side of the adjacent facing surface, wherein one end of the groove is exposed at the connecting surface, while the other end has an end face which is perpendicular to the direction of rotation of the magnetic disk.

2. The magnetic disk device of claim 1, wherein at least one end of the groove is formed in a direction of rotation of the magnetic disk by a tapered part in which a flow passage becomes narrower in a direction perpendicular to the magnetic disk.

3. The magnetic disk device of claim 1, wherein a length of the groove is half the circumference of the magnetic disk.

4. The magnetic disk device of claim 1, wherein the end face is positioned at a point in a region of the magnetic disk inner circumferential side at which a pressure is lowest.

5. The magnetic disk device of claim 1, wherein a width of the groove varies along the circumferential side.

6. The magnetic disk device of claim 5, wherein the width is less than a width of the outer circumferential region of the magnetic disk.

7. A magnetic disk device comprising:
one or more disk-shaped magnetic disks;
a spindle motor for driving the magnetic disk in rotation;
a magnetic head for reading/writing magnetic information on the magnetic disk;
an arm for supporting the magnetic head;
an enclosure base for housing the above components;
an adjacent facing surface which lies in the enclosure base adjacent to the magnetic disk;
a non-adjacent facing surface which lies in the enclosure opposite the magnetic disk and is further from the magnetic disk than the adjacent facing surface;
a connecting surface for connecting the adjacent facing surface and the non-adjacent facing surface; and
a plurality of grooves which extends in the circumferential direction of the magnetic disk on the magnetic disk inner circumferential side of the adjacent facing surface, wherein one end of at least one of the grooves is exposed at the connecting surface, while the other end has an end face which is perpendicular to the direction of rotation of the magnetic disk.

8. The magnetic disk device of claim 7, wherein at least one end of at least one of the grooves is formed in a direction of rotation of the magnetic disk by a tapered part in which a flow passage becomes narrower in a direction perpendicular to the magnetic disk.

9. The magnetic disk device of claim 7, wherein a length of at least one of the grooves is half the circumference of the magnetic disk.

10. The magnetic disk device of claim 7, wherein the end face is positioned at a point in a region of the magnetic disk inner circumferential side at which a pressure is lowest.

11. The magnetic disk device of claim 7, wherein a width of the at least one of the grooves varies along the circumferential side.

12. The magnetic disk device of claim 11, wherein the width is less than a width of the outer circumferential region of the magnetic disk.

13. A magnetic disk device comprising:
one or more disk-shaped magnetic disks;
a spindle motor for driving the magnetic disk in rotation;
a magnetic head for reading/writing magnetic information on the magnetic disk;
an arm for supporting the magnetic head;
an enclosure base for housing the above components;
an adjacent facing surface which lies in the enclosure base adjacent to the magnetic disk;
a non-adjacent facing surface which lies in the enclosure opposite the magnetic disk and is further from the magnetic disk than the adjacent facing surface;
a connecting surface for connecting the adjacent facing surface and the non-adjacent facing surface; and
a plurality of grooves which extends in the circumferential direction of the magnetic disk on the magnetic disk inner circumferential side of the adjacent facing surface, wherein one end of the groove is exposed at the connecting surface, and the groove has at least one pressure-increasing part which comprises an end face perpendicular to the direction of rotation of the magnetic disk and which checks the airflow generated by the rotation of the magnetic disk.

14. The magnetic disk device as claimed in claim 13, wherein the pressure-increasing part is formed in a direction of rotation of the magnetic disk by a tapered part in which a flow passage becomes narrower in a direction perpendicular to the magnetic disk.

15. The magnetic disk device of claim 13, wherein the at least one pressure-increasing part is wedge-shaped.

16. A magnetic disk device comprising:
one or more disk-shaped magnetic disks;
a spindle motor for driving the magnetic disk in rotation;
a magnetic head for reading/writing magnetic information on the magnetic disk;
an arm for supporting the magnetic head;
an enclosure base for housing the above components;
an adjacent facing surface which lies in the enclosure base adjacent to the magnetic disk;
a non-adjacent facing surface which lies in the enclosure opposite the magnetic disk and is further from the magnetic disk than the adjacent facing surface;
a connecting surface for connecting the adjacent facing surface and the non-adjacent facing surface; and
a groove which extends in the circumferential direction of the magnetic disk on the magnetic disk inner circumferential side of the adjacent facing surface, wherein one end of at least one of the grooves is exposed at the connecting surface, and at least one of the grooves has at least one pressure-increasing part which comprises an end face perpendicular to the direction of rotation of the magnetic disk and which checks the airflow generated by the rotation of the magnetic disk.

17. The magnetic disk device as claimed in claim 16, wherein the pressure-increasing part is formed in a direction of rotation of the magnetic disk by a tapered part in which a flow passage becomes narrower in the direction perpendicular to a magnetic disk.

18. The magnetic disk device of claim 16, wherein the at least one pressure-increasing part is wedge-shaped.
